(19) United States
(12) Patent Application Publication
(10) Pub. No.: US 2016/0155476 A1
(43) Pub. Date: Jun. 2, 2016

(54) EVENT DATA RECORDER WITH COMMUNICATION MODULE AND METHOD THEREOF

(71) Applicant: PAPAGO INC., Taipei City (TW)

(72) Inventor: Chih-Chieh FANG, Taipei City (TW)

(21) Appl. No.: 14/665,688

(22) Filed: Mar. 23, 2015

(30) Foreign Application Priority Data
Nov. 28, 2014 (TW) 103141449

(51) Int. Cl. G11B 27/10; H04N 5/77; H04N 7/18; G01S 19/42; H04N 5/232

(52) U.S. Cl. CPC G11B 27/10; G01S 19/42; H04N 5/23206; H04N 7/185; H04N 7/188; H04N 5/77

(57) ABSTRACT

An event data recorder with a communication module and a method thereof are applicable to a vehicle. The event data recorder comprises: a communication module, electrically connected to a receiving and transmitting antenna unit, for receiving and transmitting a communication signal and establishing a network connection for the communication signal; a lens, for acquiring an image record when the vehicle travels; a micro-control unit, for storing the image record into a memory unit and uploading the image record into a storage server through the network connection; and a global satellite positioning module, for acquiring position information of the vehicle, storing the position information into the memory unit, and uploading the position information into the storage server through the network connection.

### CROSS-REFERENCE TO RELATED APPLICATION

This application claims the benefit of Taiwan Patent Application No. 103141449, filed on Nov. 28, 2014, which is hereby incorporated by reference for all purposes as if fully set forth herein.

### TECHNICAL FIELD

The present invention relates to an event data recorder with a communication module and a method thereof, and in particular, to a technology for uploading an image record and position information into a storage server.

### BACKGROUND ART

Through years of technological evolution and production, functions and technologies of an event data recorder have greatly advanced. If an event data recorder is mounted in a vehicle, it is greatly helpful for monitoring driving conditions and clarifying traffic accident responsibility. Therefore, it is becoming more and more popular to mount an event data recorder in a vehicle.

The most important function of the event data recorder is storing an image record. The image record is usually stored in a local memory card. However, the memory capacity is limited and a user needs to frequently check whether or not the remaining memory capacity space is sufficient. Furthermore, the service life of hardware devices is limited. When the memory card is damaged without warning, an image cannot be recorded and, especially when an accident happens, an image record is missed, even as far as causing a key image to be unable to be recorded, with the result that driving safety risks are increased and accident judgments are inaccurate because evidential data is lacking.

### SUMMARY

With the development of the mobility, miniaturization, and popularization of wireless network communication devices, the demand for installing a wireless communication network in a mobile electronic device has gradually increased, and with the development of software intelligentization, value-added software applications of electronic devices have become broader. When an event data recorder and a communication network device are combined, the main function is not only to safely and stably store an image record and provide a backup storage space for the image record through a value-added application of the communication network, but also to provide multiple and convenient cloud management manners and an application manner for supporting a backup storage space for image records acquired by different event data recorders during driving.

The present invention provides an event data recorder with a communication module, applicable to a vehicle. The event data recorder comprises: a communication module, electrically connected to a receiving and transmitting antenna unit, for receiving and transmitting a communication signal and establishing a network connection for the communication signal; a lens, for acquiring an image record when the vehicle travels; a micro-control unit, for storing the image record into a memory unit and uploading the image record into a storage server through the network connection; and a global satellite positioning module, for acquiring position information of the event data recorder, storing the position information into the memory unit, and uploading the position information of the event data recorder into the storage server through the network connection.

The present invention provides a recording method of an event data recorder with a communication module, applicable to a vehicle, where the method comprises: electrically connecting a communication module and a receiving and transmitting antenna unit and establishing a network connection for a communication signal; acquiring, by a lens, an image record when the vehicle travels; storing the image record acquired by a micro-control unit into a memory unit and uploading the image record into a storage server through the network connection; and storing position information of the event data recorder acquired by a global satellite positioning module into the memory unit and uploading the position information of the event data recorder into the storage server through the network connection.

In an embodiment of the event data recorder with a communication module of the present invention, a monitoring device is further included. The monitoring device is connected to the storage server through a network, for acquiring the position information and the image record of the event data recorder. The monitoring device sends a request message to the storage server and the request message is transferred to the micro-control unit through the network, after receiving the request message, the micro-control unit sends back an acknowledgement message to the storage server and the acknowledgement message is transferred to the monitoring device after being acknowledged by the storage server, and the monitoring device sends back a feedback message to the micro-control unit according to the acknowledgement message, so as to acquire the position information and the image record of the event data recorder. The monitoring device simultaneously monitors a plurality of event data recorders with communication modules according to different unique identifiers in feedback messages sent back by the micro-control unit.

By using the combined structure of the event data recorder and the communication network module, the main effects of the present invention are in that safe and stable storage of the image record is provided, and it can be avoided that an image cannot be recorded when the memory card is damaged or the space is insufficient, and especially, when an accident happens, it can be avoided that an image record is missed and even a key image cannot be recorded so that driving safety risk is increased and the accident judgment is inaccurate because proof data is lacked.

Additionally, through the value-added service of the communication network, the broad software application is intended to provide a backup storage space for the image record. Cloud management can be achieved through software control to support a backup storage space for image records and position information acquired by different event data recorders during driving. Furthermore, a vehicle management function for a fleet can also be achieved by using a software application through the communication network. Global satellite positioning information is acquired by communicative connection to the network to assist in finding a lost vehicle.

### BRIEF DESCRIPTION OF DRAWINGS

FIG. 1 is a schematic component diagram of an event data recorder with a communication module of the present invention;

FIG. 2 is a schematic architecture diagram of an event data recorder with a communication module of the present invention; and

FIG. 3 is a schematic flow chart of an event data recorder with a communication module of the present invention.

### DETAILED DESCRIPTION OF THE INVENTION

In order to make the aforementioned features and advantages of the present invention more comprehensible, embodiments accompanied with figures are described in detail below.

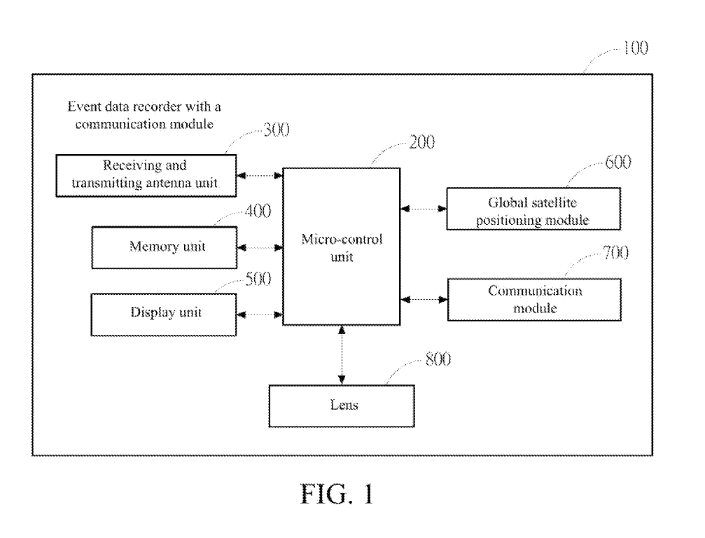

FIG. 1 is a schematic component diagram of an event data recorder 100 of the present invention. In FIG. 1, the event data recorder 100 of the present invention includes a micro-control unit 200, a storage server 210, a monitoring device 220, a receiving and transmitting antenna unit 300, a memory unit 400, a display unit 500, a global satellite positioning module 600, a communication module 700, and a lens 800.

The event data recorder 100 is applicable to all kinds of traffic vehicles and is used to record continuous image records when a vehicle travels. The event data recorder 100 includes the display unit 500 for presenting the image record. In this embodiment, the display unit 500 further includes a touch control unit for a user to input a control instruction, so as to provide and execute functions of the event data recorder. In this embodiment, a touch panel is taken as a design example of a hardware interface of the event data recorder 100 and a graphical interface menu is taken as a design example of a user interface, which are not limited thereto.

The communication module 700 of the event data recorder 100 establishes a network connection. The event data recorder 100 further includes the global satellite positioning module 600 for acquiring position information of the vehicle and storing the position information into the memory unit 400 of the event data recorder 100. The position information is uploaded into the storage server 210 in the cloud network through the network connection established by the communication module 700.

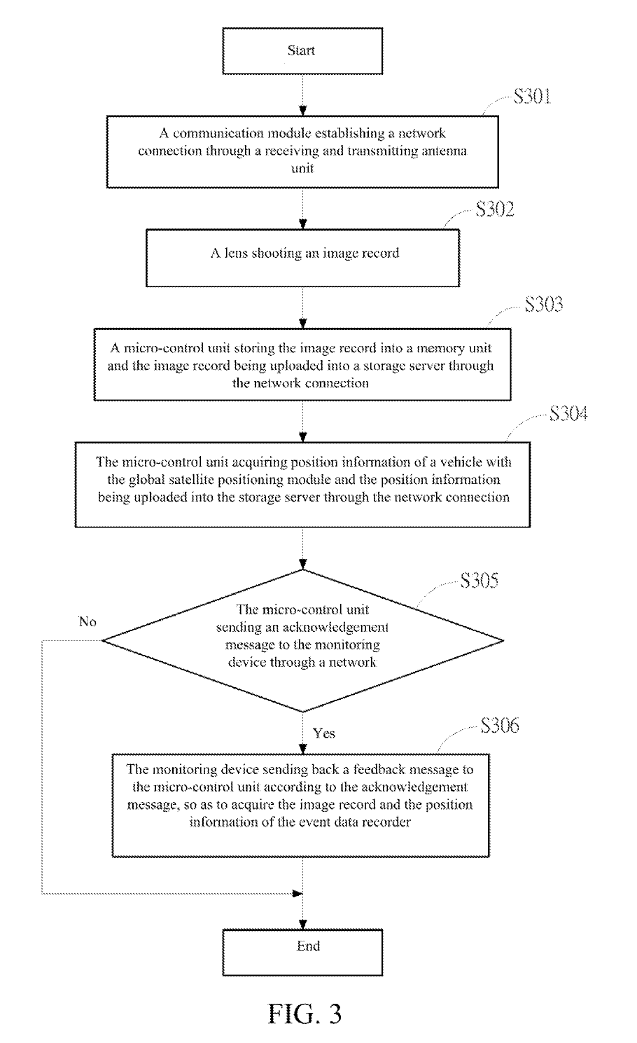

Also referring to FIG. 3, in this embodiment, the communication module 700 of the event data recorder 100 is electrically connected to the receiving and transmitting antenna unit 300, for receiving and transmitting a communication signal and establishing a network connection for the communication signal (S310). The communication network can be implemented by any one of the following wireless network communication modes: Bluetooth, 2.4G communications, 3G communications, 4G communications, 5G communications, a Wireless Local Area Network (Wi-Fi), Radio Frequency (RF) communications, and ZigBee and different kinds of wireless network communication manners may also be simultaneously supported.

In this embodiment, the receiving and transmitting antenna unit 300 can receive and transmit network signals of different base stations. Therefore, the communication module 700 of the event data recorder 100 can perform network registration among different base stations when the traffic vehicle moves and the receiving and transmitting antenna unit 300 transmits antenna signals covering a certain range and performs network communications with at least one communication device in the range.

The event data recorder 100 makes a network connection with an electronic device having a corresponding software program through a network signal so that the position information and the image record are presented. The corresponding software program may be a software program, for example, an APP program, successfully installed in the electronic device and the event data recorder after mutual authentication of the event data recorder 100 and the electronic device. The electronic device presents and uses the position information and the image record. The electronic device may be any type of electronic devices capable of being connected to the network, such as a smart phone, a smart tablet, a notebook computer, a computer, and so on.

The corresponding software program can be downloaded into the electronic device through the network and can further include a graphical user management interface for display so that the image record and the position information of the traffic vehicle can be presented and used in the electronic device. The communication module 700 of the event data recorder 100 can make a network connection. The image record can be used to develop broad value-added software application services, for example, on-line vehicle management and cloud monitoring, by operating the software program. The user can also acquire a real-time image message and files of a recorded video and saved evidence at home through the network.

Also referring to FIG. 3, in this embodiment, the image record is shot by the lens 800 (S302). Continuous image records acquired when the vehicle travels and a plurality of software programs are stored in the memory unit 400 and are used for the event data recorder 100 with the communication module of the present invention. The lens 800 is used to capture image records in different directions when the vehicle travels. The lens 800 may include, but is not limited to, a zoom lens, a long-focus lens, a telephoto lens, or a normal lens.

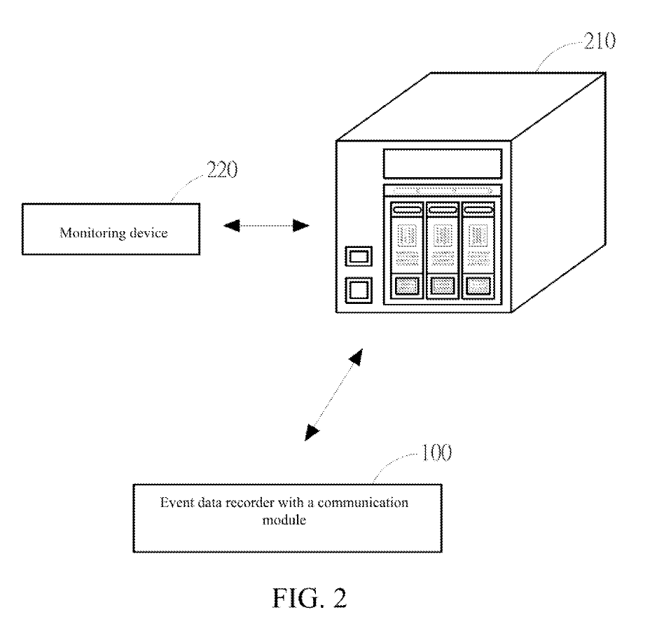

Referring to FIG. 2 and FIG. 3 together, in some embodiments, the micro-control unit 200 of the event data recorder 100 with the communication module of the present invention has a function of determining storage capacity of the memory unit 400. When the micro-control unit 200 determines that the memory unit 400 cannot store the image record because of an insufficient or damaged memory space or other factors, the image record and the position information not stored yet are uploaded into the storage server 210 of the cloud network through the network connection established by the communication module 700 (S303 and S304), thereby avoiding the loss of an important image record because of the loss of the function of the memory unit 400.

Also referring to FIG. 2, in some embodiments, the event data recorder 100 with the communication module of the present invention further includes the monitoring device 220. The monitoring device 220 is connected to the storage server 210 and the event data recorder 100 with the communication module of the present invention through a wired network or a wireless network, for acquiring the position information and the image record recorded in the traffic vehicle.

According to the foregoing description, also referring to FIG. 2 and FIG. 3, the event data recorder 100 is further described. The monitoring device 220 sends a request message to the storage server 210 and the request message is transferred to the micro-control unit 200 through the network. After receiving the request message, the micro-control unit 200 of the event data recorder 100 sends back an acknowledgement message to the storage server 210 and the acknowledgement message is transferred to the monitoring device 220 after being acknowledged by the storage server 210 (S305). The monitoring device 220 sends back a feedback message to the micro-control unit 200 according to the acknowledgement message, so as to acquire the position information and the image record of the event data recorder 100 (S306).

The micro-control unit 200 first stores the position information and the image record in the memory unit 400. After receiving the acknowledgement message, the monitoring device 220 acquires an identifier and a network address of the micro-control unit 200 and sends back a feedback message to the micro-control unit 200 (S306). Only when a network connection is established between the storage server 210 and the monitoring device 220, the position information and the image record of the event data recorder 100 can be acquired. If the monitoring device 220 does not send back a feedback message to the micro-control unit 200 or the micro-control unit 200 does not receive the feedback message sent back by the monitoring device 220, a communication network between the monitoring device 220 and the storage server 210 cannot be established, so the monitoring device 220 cannot acquire the position information and the image record of the event data recorder 100. However, the micro-control unit 200 and the storage server 210 can still store relevant driving information such as the image record and the position information of the vehicle, so as to protect information safety of the event data recorder.

Moreover, the monitoring device 220 distinguishes between different event data recorders 100 according to different unique identifiers of the micro-control units 200. The monitoring device 220 simultaneously monitors a plurality of event data recorders 100 with communication modules through network connecting, and cloud management can be achieved through software control to support a backup storage space for image records and position information acquired by event data recorders 100 with different identifiers when traffic vehicles travel. Furthermore, a vehicle management function for a fleet can also be achieved by using a software application through the communication network. A condition of a driving location is synchronously monitored in real time at the far end of the network. Global satellite positioning information is acquired by communicative connection to the network to assist in finding a lost vehicle.

In summary, by using the combined structure of the event data recorder 100 and the communication network module, the main effects of the present invention are in that safe and stable storate of the image record is provided, and it can be avoided that an image cannot be recorded when the memory card is damaged or the space is insufficient, and especially, when an accident happens, it can be avoided that an image record is missed and even a key image cannot be recorded so that driving safety risks are increased and accident judgments are inaccurate because evidential data is lacking However, attention still needs to be paid to avoiding image recording errors caused by a weak signal of the wireless network due to overdependence on a wireless communication network, a limited bandwidth or different surface features during driving, so the event data recorder 100 of the present invention still has the local memory unit 400.

For another, through the value-added service of the communication network, the broad software application is intended to provide a backup storage space for the image record. Cloud management can be achieved through software control to support a backup storage space for image records and position information acquired by different event data recorders 100 during driving. Furthermore, a vehicle management function for a fleet can also be achieved by using a software application through the communication network. A condition of a driving location is synchronously monitored in real time at the far end of the network. Global satellite positioning information is acquired by communicative connection to the network to assist in finding a lost vehicle.

The embodiments of the present invention are disclosed above, but are not intended to limit the present invention. Equivalent replacements such as variations and modifications made by any person skilled in the art without departing from the spirit and scope of the present invention still fall within the patent protection scope of the present invention.

1. An event data recorder with a communication module, applicable to a vehicle, the event data recorder characterized in that it comprises:
a communication module, electrically connected to a receiving and transmitting antenna unit, for receiving and transmitting a communication signal and establishing a network connection for the communication signal;
a lens, for acquiring an image record when said vehicle travels;
a micro-control unit, for storing said image record into a memory unit and uploading said image record into a storage server through the network connection established by said communication module; and
a global satellite positioning module, for acquiring position information of said vehicle, storing said position information into said memory unit, and uploading said position information into said storage server through the network connection established by said communication module.

2. The event data recorder with a communication module according to claim 1, characterized in that it comprises a display unit, for presenting the image record.

3. The event data recorder with a communication module according to claim 1, characterized in that it comprises a touch control unit, for inputting a control instruction, so as to provide and execute functions of the event data recorder.

4. The event data recorder with a communication module according to claim 1, characterized in that said communication module can be implemented by any one of the following wireless network communication manners: Bluetooth, 2.4G communications, 3G communications, 4G communications, 5G communications, a Wireless Local Area Network, Radio Frequency communications, and ZigBee.

5. The event data recorder with a communication module according to claim 1, characterized in that a network connection with an electronic device having a corresponding software program is made through a network signal so that the position information and the image record are presented.

6. The event data recorder with a communication module according to claim 1, characterized in that when the micro-control unit determines that the memory unit cannot store the image record, the image record is uploaded into the storage server through the network connection established by the communication module.

7. The event data recorder with a communication module according to claim 1, characterized in that the storage server further comprises a monitoring device, the monitoring device being connected to the storage server through a network, for acquiring the position information and the image record of the event data recorder.

8. The event data recorder with a communication module according to claim 7, characterized in that the monitoring device sends a request message to the storage server and the request message is transferred to the micro-control unit through the network, after receiving the request message, the micro-control unit sends back an acknowledgement message to the storage server and the acknowledgement message is transferred to the monitoring device after being acknowledged by the storage server, and the monitoring device sends back a feedback message to the micro-control unit according to the acknowledgement message, so as to acquire the position information and the image record of the event data recorder.

9. An event data recording method with a communication module, applicable to a vehicle, the method characterized in that it comprises:
establishing, by a communication module, a network connection for a communication signal;
acquiring, by a lens, at least one image record when the vehicle travels;
storing, by a micro-control unit, the image record into a memory unit and uploading the image record into a storage server through the network connection; and
acquiring, by a global satellite positioning module, position information of the vehicle, storing the position information into the memory unit, and uploading the position information into the storage server through the network connection.

10. The event data recording method with a communication module according to claim 9, characterized in that it comprises a display unit, for presenting the image record.

11. The event data recording method with a communication module according to claim 9, characterized in that it comprises a touch control unit, for inputting a control instruction, so as to provide and execute functions of the event data recorder.

12. The event data recording method with a communication module according to claim 9, characterized in that the communication module can be implemented by any one of the following wireless network communication manners: Bluetooth, 2.4G communications, 3G communications, 4G communications, 5G communications, a Wireless Local Area Network, Radio Frequency communications, and ZigBee.

13. The event data recording method with a communication module according to claim 9, characterized in that a network connection with an electronic device having a corresponding software program is made through a network signal so that the position information and the image record are presented.

14. The event data recording method with a communication module according to claim 9, characterized in that when the micro-control unit determines that the memory unit cannot store the image record, the image record is uploaded into the storage server through the network connection established by the communication module.

15. The event data recording method with a communication module according to claim 9, characterized in that the storage server further comprises a monitoring device, the monitoring device being connected to the storage server through a network, for acquiring the position information and the image record of the event data recorder.

16. The event data recording method with a communication module according to claim 15, characterized in that the monitoring device sends a request message to the storage server and the request message is transferred to the micro-control unit through the network, after receiving the request message, the micro-control unit sends back an acknowledgement message to the storage server and the acknowledgement message is transferred to the monitoring device after being acknowledged by the storage server, and the monitoring device sends back a feedback message to the micro-control unit according to the acknowledgement message, so as to acquire the position information and the image record of the event data recorder.
